(19) United States
(12) Patent Application Publication
(10) Pub. No.: US 2020/0301313 A1
(43) Pub. Date: Sep. 24, 2020

(54) DEVELOPING DEVICE, PROCESS CARTRIDGE, AND IMAGE FORMING APPARATUS

(71) Applicants: Takuya SUGANUMA, Kanagawa (JP); Tatsuya Kubo, Kanagawa (JP)

(72) Inventors: Takuya SUGANUMA, Kanagawa (JP); Tatsuya Kubo, Kanagawa (JP)

(73) Assignee: Ricoh Company, Ltd., Tokyo (JP)

(21) Appl. No.: 16/804,812

(22) Filed: Feb. 28, 2020

(30) Foreign Application Priority Data
Mar. 18, 2019 (JP) 2019-049424

(51) Int. Cl. G03G 15/08; G03G 15/09

(52) U.S. Cl. CPC G03G 15/0813; H04N 1/00602; G03G 15/087; G03G 15/0942

(57) ABSTRACT

A developing device includes a developing roller to rotate in a predetermined direction of rotation and opposed to or in contact with an image bearer to form a development range, a cover to cover the developing roller downstream from the development range in the predetermined direction of rotation, a sheet member cantilevered by the cover to contact the developing roller with a flat face of the sheet member while trailing along the predetermined direction of rotation at a position downstream from the development range. The cover includes a large gap portion to form a first gap in a first predetermined range in the predetermined direction of rotation and a small gap portion disposed adjacent to and downstream from the large gap portion in the predetermined direction of rotation to form a second gap smaller than the first gap in a second predetermined range in the predetermined direction of rotation.

### CROSS-REFERENCE TO RELATED APPLICATION

This patent application is based on and claims priority pursuant to 35 U.S.C. § 119(a) to Japanese Patent Application No. 2019-049424, filed on Mar. 18, 2019, in the Japan Patent Office, the entire disclosure of which is hereby incorporated by reference herein.

### BACKGROUND

### Technical Field

Embodiments of the present disclosure generally relate to a developing device configured to develop a latent image formed on a surface of an image bearer, a process cartridge incorporating the developing device, and an electrophotographic image forming apparatus, such as a copier, a printer, a facsimile machine, or a multifunction peripheral (MFP) having at least two of such capabilities.

### Description of the Related Art

In image forming apparatuses such as copiers, printers, facsimile machines, and MFPs, developing devices are widely used that contain a two-component developer including toner and carrier and include a cover (e.g., a housing or a development casing) to cover a developing roller downstream from a development range.

### SUMMARY

Embodiments of the present disclosure describe an improved developing device configured to develop latent images formed on a surface of an image bearer. The developing device includes a developing roller configured to rotate in a predetermined direction of rotation and opposed to or in contact with the image bearer to form a development range, a cover configured to cover the developing roller downstream from the development range in the predetermined direction of rotation, a sheet member cantilevered by the cover and configured to contact the developing roller with a flat face of the sheet member while trailing along the predetermined direction of rotation at a position downstream from the development range. The cover includes a large gap portion to form a first gap between the large gap portion and the developing roller in a first predetermined range in the predetermined direction of rotation and a small gap portion disposed adjacent to and downstream from the large gap portion in the predetermined direction of rotation to form a second gap smaller than the first gap between the small gap portion and the developing roller in a second predetermined range in the predetermined direction of rotation.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating a configuration of an image forming apparatus according to an embodiment of the present disclosure;

FIG. 2 is a schematic view illustrating a configuration of an image forming unit of the image forming apparatus in FIG. 1;

FIG. 3 is a schematic longitudinal cross-sectional view of a developing device of the image forming unit in FIG. 2;

FIG. 4 is a schematic longitudinal cross-sectional view illustrating a circulation path of the developing device in FIG. 3;

FIG. 5 is a cross-sectional view illustrating distribution of magnetic force generated around a developing roller of the developing device;

FIG. 6 is an enlarged view of a part of the developing device;

FIG. 7 is an enlarged view of a sheet member contacting the developing roller;

FIG. 8 is an enlarged view of a part of a developing device according to a comparative example;

FIG. 9 is an enlarged view of a part of a developing device according to another comparative example;

FIG. 10A is an enlarged view of a part of a developing device according to yet another comparative example; and

FIG. 10B is an enlarged view of a part of a developing device according to still yet another comparative example.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

Embodiments of the present disclosure are described in detail with reference to drawings. It is to be understood that identical or similar reference numerals are assigned to identical or corresponding components throughout the drawings, and redundant descriptions are omitted or simplified below as required.

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

It is to be noted that the suffixes Y, M, C, and BK attached to each reference numeral indicate only that components indicated thereby are used for forming yellow, magenta, cyan, and black images, respectively, and hereinafter may be omitted when color discrimination is not necessary.

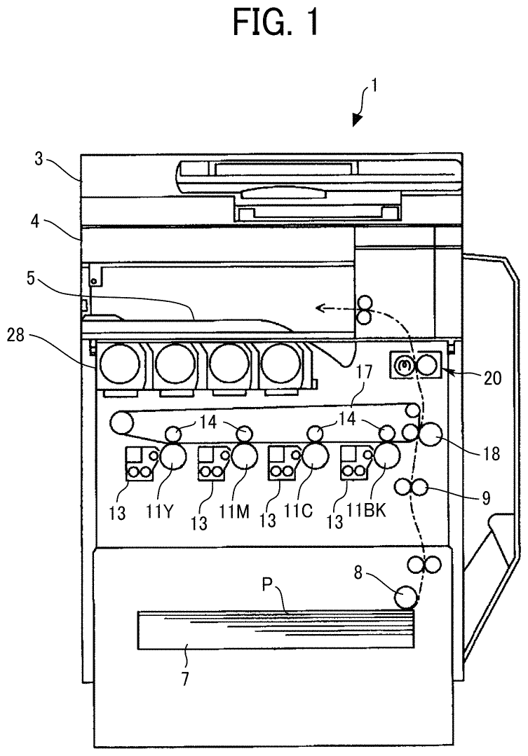

A configuration and operation of an image forming apparatus 1 is described below with reference to FIG. 1.

In FIG. 1, the image forming apparatus 1, which is a tandem color copier in the present embodiment, includes a document conveyance device 3, a scanner (document reading device) 4, an output tray 5, a sheet feeding device 7, and a registration roller pair 9. The document conveyance device 3 feeds a document to the scanner 4. The scanner 4 scans image data for the document. The sheet feeding device 7 contains sheets P such as paper sheets. The registration roller pair (timing roller pair) 9 adjusts the timing of conveyance of the sheet P. Output images are stacked on the output tray 5.

The image forming apparatus 1 also includes photoconductor drums 11Y, 11M, 11C, and 11BK as image bearers, developing devices 13, primary transfer rollers 14, and an intermediate transfer belt 17 as an intermediate transferor. Electrostatic latent images are formed on surfaces of the photoconductor drums 11Y, 11M, 11C, and 11BK and developed into toner images of yellow, magenta, cyan, and black by the developing devices 13. The toner images on the surfaces of the photoconductor drums 11Y, 11M, 11C, and 11BK (hereinafter, also collectively referred to as “photoconductor drums 11”) are transferred to and superimposed on the intermediate transfer belt 17 by the primary transfer rollers 14, thereby forming a multicolor toner image on the intermediate transfer belt 17.

The image forming apparatus 1 further includes a secondary transfer roller 18, a fixing device 20, and toner containers 28. The secondary transfer roller 18 transfers the multicolor toner image on the intermediate transfer belt 17 onto the sheet P. The fixing device 20 fixes the multicolor toner image (unfixed image) on the sheet P. The toner containers 28 contain yellow, magenta, cyan, and black toners to supply the toners to the developing devices 13.

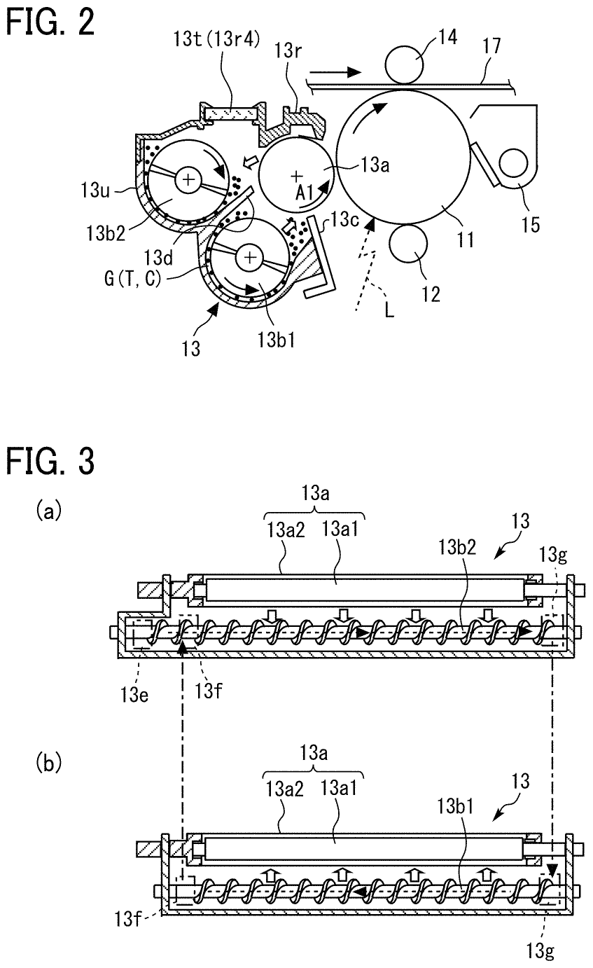

A description is provided below of the operation of the image forming apparatus 1 when forming a normal color image with continued reference to FIG. 1 as well as FIG. 2. FIG. 2 is a schematic view illustrating a configuration of an image forming unit of the image forming apparatus 1 in FIG. 1.

A conveyance roller of the document conveyance device 3 transports a document on a document table onto a platen (exposure glass) of the scanner 4. Then, the scanner 4 optically scans image data for the document on the platen.

More specifically, the scanner 4 scans an image of the document on the platen with light emitted from an illumination lamp. The light reflected from a surface of the document is directed onto a color sensor via mirrors and lenses to form multicolor image data. The multicolor image data for the document, which is decomposed into red, green, and blue (RGB) data, is read by the color sensor and converted into electrical image signals. Further, an image processor performs image processing (e.g., color conversion, color calibration, and spatial frequency adjustment) according to the image signals of the decomposed RGB data, and thus image data for yellow, magenta, cyan, and black toner images are obtained.

The image data for yellow, magenta, cyan, and black toner images are transmitted to a writing device. The writing device directs a laser beam L (see FIG. 2) onto a surface of the corresponding photoconductor drum 11 according to the image data for each color.

Meanwhile, the four photoconductor drums 11 rotate clockwise as illustrated in FIGS. 1 and 2. Initially, the surface of each photoconductor drum 11 is uniformly charged by a charging device 12 (see FIG. 2) at a position facing each other (charging process). Thus, the surface of the photoconductor drum 11 is charged to a certain potential. Subsequently, the charged surface of the photoconductor drum 11 reaches a position where the surface is scanned by the laser beam L.

The writing device emits the laser beam L from each of four light sources according to the image data. The respective laser beams L pass through different optical paths for the different components of yellow, magenta, cyan, and black (exposure process).

The laser beam L corresponding to the yellow component is directed onto the surface of the photoconductor drum 11Y that is the first from the left in FIG. 1 among the four photoconductor drums 11Y, 11M, 11C, and 11BK. A polygon mirror that rotates at high velocity deflects the laser beam L for yellow along the axis of rotation of the photoconductor drum 11 (i.e., the main-scanning direction) so that the laser beam L scans the surface of the photoconductor drum 11. Thus, an electrostatic latent image for yellow is formed on the surface of the photoconductor drum 11Y charged by the charging device 12.

Similarly, the laser beam L corresponding to the magenta component is directed onto the surface of the photoconductor drum 11M that is the second from the left in FIG. 1, thus forming an electrostatic latent image for magenta thereon. The laser beam L corresponding to the cyan component is directed onto the surface of the photoconductor drum 11C that is the third from the left in FIG. 1, thus forming an electrostatic latent image for cyan thereon. The laser beam L corresponding to the black component is directed onto the surface of the photoconductor drum 11BK that is the fourth from the left in FIG. 1, thus forming an electrostatic latent image for black thereon.

Then, the surface of the photoconductor drum 11 having the electrostatic latent image reaches a position opposite the developing device 13. The developing device 13 deposits toner of each color onto the photoconductor drum 11 and develops the electrostatic latent image on the surface of the photoconductor drum 11 into a visible toner image (development process).

After the development process, the surfaces of the photoconductor drums 11 reach positions facing the intermediate transfer belt 17. The primary transfer rollers 14 are disposed at positions where the photoconductor drums 11 face the intermediate transfer belt 17 and in contact with an inner surface of the intermediate transfer belt 17, respectively. At the positions of the primary transfer rollers 14, the toner images on the photoconductor drums 11Y, 11M, 11C, and 11BK are transferred to and superimposed on the intermediate transfer belt 17, thereby forming a multicolor toner image thereon (primary transfer process).

After the primary transfer process, the surface of the photoconductor drum 11 reaches a position opposite a cleaning device 15. The cleaning device 15 collects untransferred toner remaining on the surface of the photoconductor drum 11 (cleaning process).

Then, the surface of the photoconductor drum 11 passes through a discharge device to complete a series of image forming processes performed on the photoconductor drum 11.

The multicolor toner image is formed on a surface of the intermediate transfer belt 17 by transferring and superimposing the respective single-color toner images formed on the photoconductor drums 11. Then, the intermediate transfer belt 17 carrying the multicolor toner image moves counterclockwise in FIG. 1 to reach a position opposite the secondary transfer roller 18. The secondary transfer roller 18 secondarily transfers the multicolor toner image carried on the intermediate transfer belt 17 onto the sheet P at the position between the secondary transfer roller 18 and the intermediate transfer belt 17 (secondary transfer process).

After the secondary transfer process, the surface of the intermediate transfer belt 17 reaches a position opposite a belt cleaning device. The belt cleaning device collects untransferred toner adhering to the intermediate transfer belt 17 to complete a sequence of transfer processes performed on the intermediate transfer belt 17.

The sheet P is transported from the sheet feeding device 7 via the registration roller pair 9 to a secondary transfer nip between the intermediate transfer belt 17 and the secondary transfer roller 18.

More specifically, a sheet feeding roller 8 feeds the sheet P from the sheet feeding device 7 that contains a stack of sheets P, and the sheet P is then guided by a sheet guide to the registration roller pair 9. The sheet P that has reached the registration roller pair 9 is transported toward the secondary transfer nip, timed to coincide with the arrival of the multicolor toner image on the intermediate transfer belt 17.

Then, the sheet P carrying the multicolor toner image is transported to a fixing device 20. The fixing device 20 includes a fixing roller and a pressure roller pressing against each other. In a nip between the fixing roller and the pressure roller, the multicolor toner image is fixed on the sheet P.

After the fixing process, an output roller pair ejects the sheet P as an output image outside the image forming apparatus 1, and the ejected sheet P is stacked on the output tray 5. Thus, a series of the image forming processes is completed.

Next, an image forming unit of the image forming apparatus 1 is described in further detail below with reference to FIGS. 2 to 5.

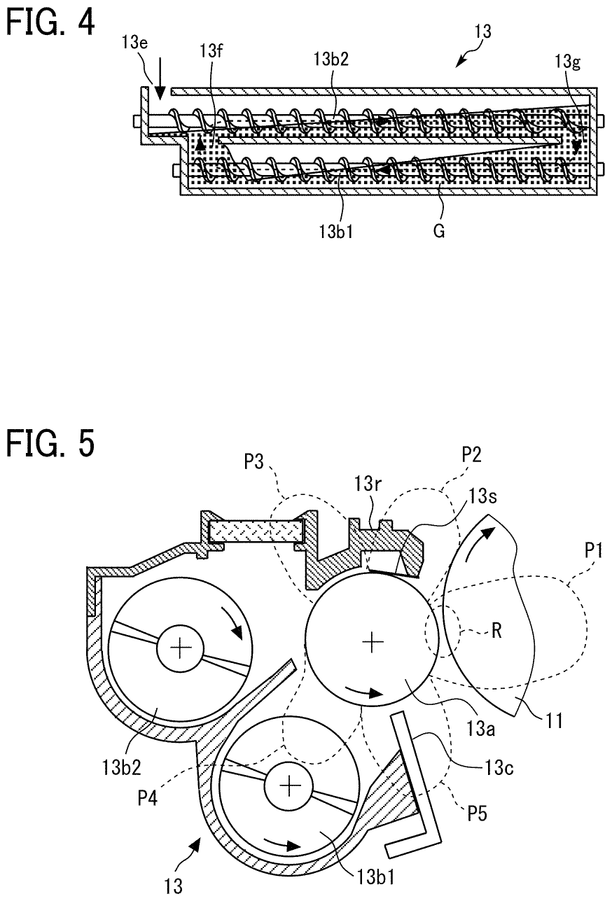

FIG. 2 is a schematic view illustrating a configuration of the image forming unit. A part (a) of FIG. 3 is a horizontal schematic cross-sectional view of an upper portion of the developing device 13 as viewed along a longitudinal direction of the developing device 13. In the part (a) of FIG. 3, a second conveying screw 13b2 as a conveyor for collecting the developer is disposed in a collection path of the upper portion. A part (b) of FIG. 3 is a schematic cross-sectional view of a lower portion of developing device 13 as viewed along the longitudinal direction of the developing device 13. In the part (b) of FIG. 3, a first conveying screw 13b1 as a conveyor for supplying the developer is disposed in a supply path of the lower portion. FIG. 4 is a vertical schematic cross-sectional view illustrating a circulation path of the developer in the developing device 13 as viewed along the longitudinal direction of the developing device 13. FIG. 5 is a cross-sectional view illustrating distribution of magnetic force generated around a developing roller 13a of the developing device 13.

It is to be noted that the suffixes Y, M, C, and BK of components of the image forming units, such as the photoconductor drum 11, the developing device 13, and the like are omitted in FIGS. 2 to 5 for simplicity because the image forming units have a similar configuration.

As illustrated in FIG. 2, each image forming unit includes the photoconductor drum 11 as the image bearer, the charging device 12, the developing device 13, the cleaning device 15, and the like.

The photoconductor drum 11 as the image bearer in the present embodiment is a negatively-charged organic photoconductor and is rotated clockwise in FIG. 2 by a drive motor.

The charging device 12 is an elastic charging roller and can be formed by covering a core with an elastic layer of moderate resistivity, such as foamed urethane layer, that includes carbon black as conductive particles, sulfuration agent, foaming agent, and the like. The material of the elastic layer of moderate resistivity of the charging device 12 includes, but not limited to, rubber such as urethane, ethylene-propylene-diene-polyethylene (EPDM), acrylonitrile butadiene rubber (NBR), silicone rubber, and isoprene rubber to which conductive material such as carbon black or metal oxide is added to adjust the resistivity. Alternatively, foamed rubber including these materials may be used.

The cleaning device 15 includes a cleaning blade that slidingly contacts the surface of the photoconductor drum 11 and mechanically removes untransferred toner on the photoconductor drum 11.

The developing device 13 includes a developing roller 13a, serving as a developer bearer, opposed to the photoconductor drum 11 across a slight gap. A development range R (see FIG. 5) where a magnetic brush formed on the developing roller 13a contacts the photoconductor drum 11 is formed in a portion where the developing roller 13a is opposed to the photoconductor drum 11. The developing device 13 contains a two-component developer G including toner T and carrier C. The developing device 13 develops the electrostatic latent image on the photoconductor drum 11 into the toner image. The configuration and operation of the developing device 13 are described in further detail later.

The toner containers 28 contain toner T to be supplied to the developing devices 13. Specifically, the developing device 13 includes a magnetic sensor to detect toner concentration (i.e., a ratio of toner T to the developer G). Depending on the toner concentration detected by the magnetic sensor, the toner T is supplied from the toner container 28 to the developing device 13 via a toner conveyance tube and a toner supply inlet 13e (see FIGS. 3 and 4).

In the present embodiment, any toner can be used as the toner T in the developer G and the toner T in the toner container 28, and any carrier can be used as the carrier C in the developer G.

Next, the developing device 13 of the image forming apparatus 1 is described in further detail below.

With reference to FIGS. 2 to 5, it can be seen that the developing device 13 includes the developing roller 13a serving as a developer bearer, the first conveying screw 13b1 and the second conveying screw 13b2 (i.e., auger screws) serving as the conveyors, and a doctor blade 13c serving as a developer regulator.

The developing roller 13a includes a cylindrical sleeve 13a2 made of a nonmagnetic material and rotates counterclockwise in FIG. 2 by a drive motor as a driver. The nonmagnetic material includes, but is not limited to, aluminum, stainless steel, brass, and conductive resin.

A casing of the developing device 13 has an opening so that the developing roller 13a is opposed to the photoconductor drum 11 in the development range R. In other words, when the developing device 13 is viewed alone, a part of the developing roller 13a is exposed from the opening.

A magnet 13a 1 as a magnetic field generator is secured inside the sleeve 13a2 of the developing roller 13a to generate a magnetic field as illustrated in FIG. 3. The magnet (magnetic field generator) 13a 1 forms distribution of magnetic force exerted by a plurality of magnetic poles P1 to P5 (see FIG. 5) around a circumference of the sleeve 13a2. In other words, the developing roller 13a includes the magnetic poles P1 to P5 each having a peak of the normal magnetic force in a predetermined region in a predetermined direction of rotation of the developing roller 13a (hereinafter, referred to as the “rotation direction”). The magnetic poles P1 to P5 are disposed at a plurality of positions (five positions in the present embodiment) around the entire circumference of the developing roller 13a in the rotation direction, respectively.

The developer G carried on the developing roller 13a is transported to the doctor blade 13c, serving as the developer regulator, as the developing roller 13a rotates in the predetermined direction of rotation (in the present embodiment, counterclockwise as indicated by arrow A1 in FIG. 2). An amount of developer G on the developing roller 13a is suitably adjusted by the doctor blade 13c, after which the developer G is transported to the development range R opposite the photoconductor drum 11 illustrated in FIG. 5. Then, toner T in the developer G is attracted to the latent image formed on the photoconductor drum 11 due to the effect of an electric field for development generated in the development range R.

Specifically, with reference to FIG. 5, it can be seen that the scooping pole P4 of the plurality of magnetic poles acts on the magnetic carrier C in the developer G, and thus the developer G contained in the supply path, in which the first conveying screw 13b1 is disposed, of the developing device 13 is partially scooped up on the developing roller 13a. A part of the developer G carried on the developing roller 13a is scraped off by the doctor blade 13c and returned to the supply path. The developer G passes through a doctor gap between the doctor blade 13c and the developing roller 13a where the pre-main pole P5 acts. Then, the grains of the developer G carried on the developing roller 13a stand on end on the developing roller 13a due to the magnetic force exerted by the main magnetic pole P1 of the plurality of magnetic poles, forming a magnetic brush in the development range R and slidingly contact the photoconductor drum 11. Thus, the toner T in the developer G carried on the developing roller 13a adheres to the latent image formed on the photoconductor drum 11. After passing through the development range R where the main magnetic pole P1 acts, the developer G passes between an upper cover 13r and the developing roller 13a by the magnetic force exerted by the conveyance poles P2 and P3 and is transported to a position corresponding to a developer release pole between the magnetic poles P3 and P4. Then, at the position corresponding to the developer release pole, magnetic repulsion to separate the developer G from the developing roller 13a acts on the carrier C, and the developer G carried on the developing roller 13a after the development process is removed from the developing roller 13a. Then, the developer G falls into the collection path of the developing device 13 and is transported downstream by the second conveying screw 13b2 therein.

With reference to FIG. 2, in the present embodiment, the doctor blade 13c as the developer regulator is a nonmagnetic plate disposed below the developing roller 13a. Alternatively, in another embodiment, a portion of the doctor blade 13c can be made of a magnetic material. The doctor blade 13c is opposed to the developing roller 13a below the developing roller 13a, serving as the developer regulator to adjust the amount of the developer G carried on the developing roller 13a.

In FIG. 2, the developing roller 13a rotates counterclockwise, and the photoconductor drum 11 rotates clockwise.

The first and second conveying screws 13b1 and 13b2 stir the developer G contained in the developing device 13 while circulating the developer G in the longitudinal direction of the developing device 13 (hereinafter also referred to as a “developer conveyance direction”), perpendicular to the surface of the paper on which FIG. 2 is drawn.

The first conveying screw 13b1 as the conveyor for supplying the developer G is opposed to the developing roller 13a and supplies the developer G to the developing roller 13a as indicated by blank arrows illustrated in the part (b) of FIG. 3 at the position corresponding to the scooping pole P4 while horizontally transporting the developer G in the developer conveyance direction to the left in the FIG. 3 as indicated by the broken-line arrow illustrated in the part (b) of FIG. 3. The first conveying screw 13b1 rotates counterclockwise in FIG. 2.

The second conveying screw 13b2 as the conveyor for collecting the developer G is disposed above the first conveying screw 13b1 and opposite the developing roller 13a. The second conveying screw 13b2 horizontally transports the developer G that has been forcibly separated from the developing roller 13a by the developer release pole in the direction indicated by blank arrows in the part (a) of FIG. 3 to the right in FIG. 3 as indicated by the broken-line arrow illustrated in the part (a) of FIG. 3. In the present embodiment, the second conveying screw 13b2 rotates in the direction opposite to the developing roller 13a (i.e., clockwise in FIG. 2).

As indicated by alternate long and short dashed arrows in FIG. 3, the developer G is transported from the downstream side of the supply path (hereinafter, also referred to as “a first transport path”) in which the first conveying screw 13b1 is disposed, through a first communication opening 13f, and to the upstream side of the collection path (hereinafter, also referred to as “a second transport path”) in which the second conveying screw 13b2 is disposed. Then, the second conveying screw 13b2 transports the developer G downstream in the collection path (the second transport path) and to the upstream side of the supply path (the first transport path) through a second communication opening 13g.

The first and second conveying screws 13b1 and 13b2 are disposed so that axes of rotation of the first and second conveying screws 13b1 and 13b2 are substantially horizontal similar to the developing roller 13a and the photoconductor drum 11. Each of the first and second conveying screws 13b1 and 13b2 includes a shaft and a helical blade wound around the shaft.

The first and second conveying screws 13b1 and 13b2 and the developing roller 13a constitute a drive system with a gear train and are driven to rotate by the drive motor as the driver. That is, a controller causes the drive motor to rotate the first and second conveying screws 13b1 and 13b2 along with the developing roller 13a.

An inner wall (a partition) 13d of the developing device 13 separates the first transport path (the supply path) in which the first conveying screw 13b1 is disposed and the second transport path (the collection path) in which the second conveying screw 13b2 is disposed.

With reference to FIGS. 3 and 4, it can be seen that the downstream side of the second transport path (the collection path), in which the second conveying screw 13b2 is disposed, communicates with the upstream side of the first transport path (the supply path), in which the first conveying screw 13b1 is disposed, via the second communication opening 13g. In the downstream end portion of the second transport path in which the second conveying screw 13b2 is disposed, the developer G falls through the second communication opening 13g to the upstream end portion of the first transport path.

With reference to FIGS. 3 and 4, it can be seen that the downstream side of the first transport path, in which the first conveying screw 13b1 is disposed, communicates with the upstream side of the second transport path, in which the second conveying screw 13b2 is disposed, via the first communication opening 13f. In the first transport path in which the first conveying screw 13b1 is disposed, the developer G that is not supplied to the developing roller 13a accumulates adjacent to the first communication opening 13f and then is transported or supplied via the first communication opening 13f to the upstream end portion of the second transport path in which the second conveying screw 13b2 is disposed.

It is to be noted that a paddle or a screw wound in the direction opposite to the helical blade of the first conveying screw 13b1 may be provided on the downstream portion of the first conveying screw 13b1 to facilitate conveyance of the developer G at the position corresponding to the first communication opening 13f, which is conveyance from the supply path to the collection path against gravity.

This configuration provides the circulation path through which the developer G is circulated in the longitudinal direction by the first and second conveying screws 13b1 and 13b2 in the developing device 13. That is, when the developing device 13 operates, the developer G contained therein flows in the developer conveyance direction indicated by the broken arrows illustrated in FIGS. 3, and 4. Separating the first transport path (the supply path), in which the first conveying screw 13b1 supplies the developer G to the developing roller 13a, from the second transport path (the collection path), to which the developer G is collected from the developing roller 13a by the second conveying screw 13b2, can reduce density unevenness of toner images formed on the photoconductor drum 11.

The magnetic sensor to detect the toner concentration in the developer G circulated in the developing device 13 is disposed in the second transport path (the collection path) in which the second conveying screw 13b2 is disposed. Based on the toner concentration detected by the magnetic sensor, the fresh toner T is supplied from the toner container 28 to the developing device 13 through the toner supply inlet 13e disposed near the first communication opening 13f.

Additionally, with reference to FIGS. 3 and 4, it can be seen that the toner supply inlet 13e is disposed above the upstream side of the second transport path, in which the second conveying screw 13b2 is disposed, away from the development range R, that is, disposed outside the area occupied by the developing roller 13a in the longitudinal direction. Since the toner supply inlet 13e is disposed near the first communication opening 13f, the developer G separated from the developing roller 13a falls on the supplied toner T, which has a small specific gravity, in the collection path, and the supplied toner T is sufficiently dispersed in and mixed with the developer G over a relatively extended period of time toward the downstream side of the collection path.

It is to be noted that the position of the toner supply inlet 13e is not limited to inside the collection path (the second transport path) in which the second conveying screw 13b2 is disposed but can be disposed above the upstream portion of the supply path, for example.

With reference to FIGS. 2 and 5, it can be seen that the developing device 13 according to the present embodiment includes the upper cover 13r as a cover to cover the developing roller 13a downstream from the development range R in the rotation direction of the developing roller 13a.

The upper cover 13r as the cover is provided to cover the upper side of the developing device 13 (a range including the upper side of the developing roller 13a). The upper cover 13r functions as the exterior or the casing of the developing device 13 together with a lower cover 13u to cover the lower side of the developing device 13. In the present embodiment, the upper cover 13r and the lower cover 13u are made of a resin material such as acrylonitrile butadiene styrene (ABS) or polycarbonate (PC).

In the present embodiment, the casing of the developing device 13 is divisible into the upper cover 13r and the lower cover 13u. However, the configuration of the casing of the developing device 13 is not limited to the above-described embodiments, and various types of configurations can be used.

With reference to FIG. 2, it can be seen that the upper cover 13r as the cover has the vent (an opening) 13r4 that enables air to flow inside and outside the developing device 13. The developing device 13 includes a filter 13t that covers the vent 13r4 of the upper cover (cover) 13r to collect toner and ventilate.

In other words, a flow path to vent the air from the inside to the outside of the developing device 13 is formed in the upper cover 13r. The filter 13t is installed in the upper cover 13r to cover a part of the flow path. The filter 13t electrostatically attracts and collects toner T and carrier C to allow only air to pass through.

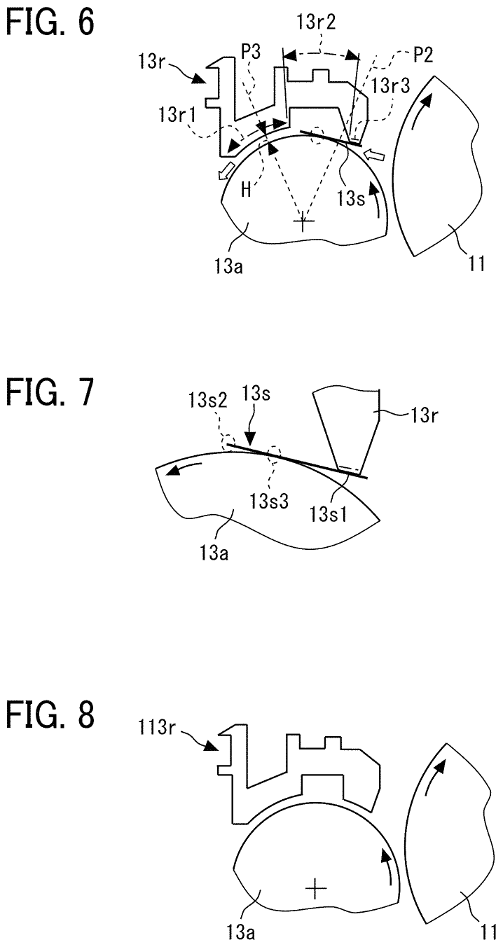

In a casing gap H (see FIG. 6) between the developing roller 13a and the upper cover 13r, the developer G carried on the developing roller 13a slidingly contacts the inner face of the upper cover 13r, and a suction airflow toward the interior of the developing device 13 is generated due to a pump action as indicated by the blank arrows in FIG. 6. As a result, toner scattering from the developing device 13 (which is scattering of toner to the periphery of the development range R) is less likely to occur because of the suction airflow.

However, the internal pressure of the developing device 13 is likely to increase due to the suction airflow, and if the internal pressure increases, toner scattering may occur from gaps of the developing device 13. On the other hand, in the present embodiment, since the vent 13r4 covered by the filter 13t is provided to collect the toner T, only air is vented while preventing the toner T from scattering to the outside. As a result, the increase of the internal pressure of the developing device 13 is minimized. That is, this configuration inhibits toner scattering caused by the increase of the internal pressure of the developing device 13.

The configuration and operation of the developing device 13 according to the present embodiment are described below.

As described above with reference to FIG. 2, the developing device 13 includes the upper cover 13r as the cover to cover the developing roller 13a downstream from the development range R in the rotation direction of the developing roller 13a.

Furthermore, as illustrated in FIGS. 6 and 7, the developing device 13 according to the present embodiment includes a sheet member 13s cantilevered by the upper cover 13r. The sheet member 13s contacts the developing roller 13a with a flat face of the sheet member 13s, trailing along rotation of the developing roller 13a, downstream from the developing range R in the rotation direction.

Specifically, as illustrated in FIG. 7, the sheet member 13s is sheet-shaped and made of a flexible material such as polyurethane having a thickness of about 0.1 mm, and a root 13s1 of the sheet member 13s is adhered to the upper cover 13r with double-sided tape. The sheet member 13s is cantilevered by the upper cover 13r such that the root 13s1 is a secured end and a tip 13s2 of the sheet member 13s is a free end. Further, the free end tip 13s2 of the sheet member 13s is contactless with the developing roller 13a, but the flat face between the root (secured end) 13s1 and the free end tip 13s2 contacts the developing roller 13a, serving as a contact portion 13s3. The sheet member 13s contacts the developing roller 13a substantially in the entire range in the longitudinal direction of the developing roller 13a (at least in the range in which the developer G is carried in the longitudinal direction).

In the present embodiment, the length of the sheet member 13s is about 9 mm, and the length of the root 13s1 (sticking width) is about 3 mm in the lateral direction perpendicular to the longitudinal direction. The sheet member 13s contacts the developing roller 13a, inclining at about 15 degrees with respect to the horizontal plane.

As illustrated in FIG. 6, the upper cover 13r as the cover includes a large gap portion 13r2 and a small gap portion 13r1.

The large gap portion 13r2 forms a first gap (large gap) between the developing roller 13a and the upper cover 13r in a first predetermined range in the rotation direction indicated by the broken-line, double-headed arrow in FIG. 6. When the upper cover 13r is viewed from the developing roller 13a, the large gap portion 13r2 is concave in a trench shape. Therefore, the large gap portion 13r2 is disposed away from the developing roller 13a across the first gap larger than a second gap of a small gap portion 13r1 to be described later, thereby forming a space.

The small gap portion 13r1 is disposed adjacent to and downstream from the large gap portion 13r2 in the rotation direction (left side in FIG. 6). The small gap portion 13r1 forms a second gap (a small gap or the casing gap H) between the developing roller 13a and the upper cover 13r in a second predetermined range in the rotation direction indicated by the broken-line, double-headed arrow in FIG. 6. The second gap is substantially constant in the second predetermined range. The small gap portion 13r1 is provided in a substantially concentric arc shape with the outer circumferential face of the developing roller 13a. Accordingly, the substantially constant small gap (the casing gap H) is formed between the developing roller 13a and the small gap portion 13r1 in the rotation direction.

In the present embodiment, the first gap between the large gap portion 13r2 and the developing roller 13a is about 3 mm, and the second gap (the casing gap H) between the small gap portion 13r1 and the developing roller 13a is about 1 mm.

As described above, the developing device 13 according to the present embodiment includes the upper cover 13r including the small gap portion 13r1 and the large gap portion 13r2, and the sheet member 13s that contacts the developing roller 13a with the flat face of the sheet member 13s. As a result, toner scattering from the developing device 13 is substantially reduced.

Specifically, as described above, the suction airflow in the direction indicated by the blank arrows in FIG. 6 is formed in the gap between the developing roller 13a and the upper cover 13r due to the pump action. This suction airflow is generated by the developer G carried on the developing roller 13a, which slidingly contacts the upper cover 13r in the second gap (the casing gap H) between the developing roller 13a and the small gap portion 13r1. The first gap between the developing roller 13a and the large gap portion 13r2 is large enough to inhibit the developer G carried on the developing roller 13a from slidingly contacting the large gap portion 13r2 of the upper cover 13r. Therefore, the suction airflow in the direction indicated by the blank arrows in FIG. 6 is formed by the casing gap H between the developing roller 13a and the small gap portion 13r1. However, the casing gap H is not even in the longitudinal direction (perpendicular to the surface of the paper on which FIG. 6 is drawn), and a certain degree of deviation (variation) of the casing gap H occurs. In such a case, the suction airflow becomes weak where the casing gap H is large, and the suction airflow becomes strong where the casing gap H is small. As a result, toner is likely to blow backward in the direction opposite the blank arrows in FIG. 6 where the suction airflow is weak, causing toner scattering. That is, toner scatters through the opening, which forms the development range R, of the developing device 13 without the sheet member 13s like a comparative upper cover 113r illustrated in FIG. 8.

On the other hand, in the present embodiment, the sheet member 13s that contacts the developing roller 13a is disposed downstream from the development range R. Therefore, even if toner erupts together with air where the suction airflow is weak in the casing gap H between the developing roller 13a and the small gap portion 13r1, the sheet member 13s blocks the erupting toner and air, thereby preventing toner scattering outside the developing device 13.

In addition, even if air erupts where the suction airflow is weak, the erupting air stays in the space formed between the developing roller 13a and the large gap portion 13r2 while being blocked by the sheet member 13s. Then, the air is sucked through the casing gap H where the suction airflow is strong into the circulation path of the developing device 13. In other words, the space between the developing roller 13a and the large gap portion 13r2 functions as a buffer that cancels the unevenness of the strength of the suction airflow due to the deviation of the casing gap H in the longitudinal direction.

In the present embodiment, the upper cover 13r includes the small gap portion 13r1 and the large gap portion 13r2, and the sheet member 13s is provided for reducing the eruption of air and toner from the space formed by the large gap portion 13r2 to the outside of the developing device 13. Therefore, even if the casing gap H is uneven in the longitudinal direction, the suction airflow is formed satisfactorily, thereby preventing toner scattering through the opening, which forms the development range R, of the developing device 13.

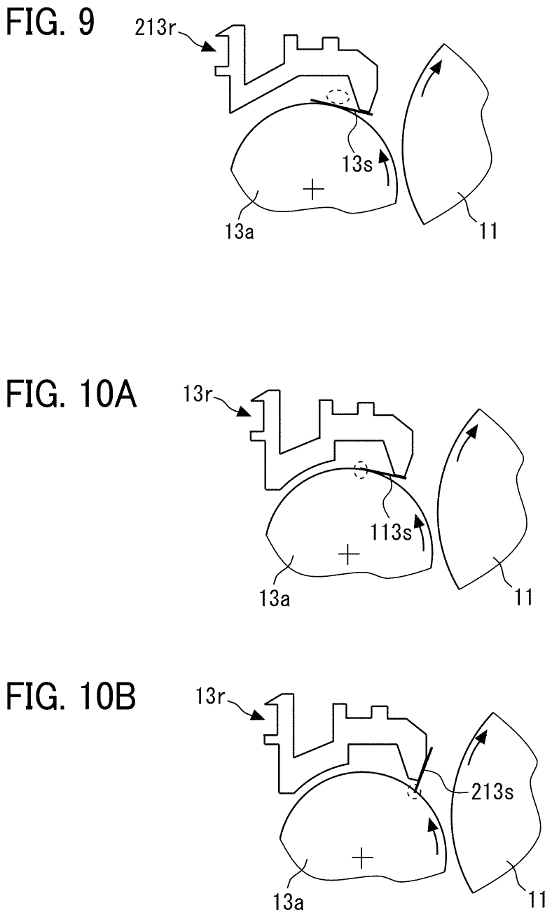

In the present embodiment, the small gap portion 13r1 of the upper cover 13r causes the above-described suction airflow to be formed in the gap between the upper cover 13r and the developing roller 13a, thereby reducing toner scattering. In the case without the small gap portion 13r1 like another comparative upper cover 213r illustrated in FIG. 9, even if the sheet member 13s is provided, the suction airflow is not satisfactorily formed in the gap between the comparative upper cover 213r and the developing roller 13a, causing toner scattering.

Further, without the small gap portion 13r1 like the comparative upper cover 213r illustrated in FIG. 9, when the developing device 13 is removed from the image forming apparatus 1 and inclined, the developer G may flow backward and remain on the upper surface of the sheet member 13s surrounded by the broken-line circle in FIG. 9. As a result, if the developing process is restarted in such a state in which the developer G remains on the sheet member 13s, the sheet member 13s described above does not function satisfactorily.

In the present embodiment, since the sheet member 13s is cantilevered, the sheet member 13s does not strongly contact the developer G carried on the developing roller 13a, differing from the case in which the sheet member 13s is supported at both ends. Therefore, the sheet member 13s does not block the developer G. Further, since the sheet member 13s is cantilevered, even if the thickness of layer of the developer G carried on the developing roller 13a fluctuates or varies in the longitudinal direction, the state in which the sheet member 13s contacts the developing roller 13a is less likely to change.

In the present embodiment, since the sheet member 13s contacts the developing roller 13a with the flat face of the sheet member 13s, the state in which the sheet member 13s contacts the developing roller 13a is less likely to change regardless of assembly tolerances or component tolerances, differing from the case in which the tips of comparative sheet members 113s and 213s contact the developing roller 13a as illustrated in FIGS. 10A and 10B. Further, since the sheet member 13s contacts the developing roller 13a with the flat face of the sheet member 13s, the sheet member 13s does not prevent the suction airflow from outside the developing device 13. As a result, the state in which the sheet member 13s contacts the developing roller 13a is less likely to change.

For all these reasons, the sheet member 13s stably exhibits the above-described functions.

As illustrated in FIG. 6, in the present embodiment, the sheet member 13s contacts the developing roller 13a with the flat face of the sheet member 13s at the position opposite the large gap portion 13r2.

That is, the contact portion 13s3 surrounded by the broken-line circle in FIG. 6 of the sheet member 13s is located at a position facing the large gap portion 13r2 (i.e., within the range where the large gap portion 13r2 is disposed).

With this configuration, the above-described functions of the sheet member 13s and the large gap portion 13r2 are stably exhibited. That is, even if air erupts where the suction airflow is weak in the casing gap H, the erupting air stays in the space formed between the developing roller 13a and the large gap portion 13r2 while being blocked by the sheet member 13s. Then, the air staying in the space is sucked through the casing gap H where the suction airflow is strong into the circulation path of the developing device 13.

As illustrated in FIG. 6, in the present embodiment, the small gap portion 13r1 of the upper cover 13r is opposed to the magnetic pole P3 that is one of the plurality of magnetic poles P1 to P5 of the developing roller 13a described above with reference to FIG. 5.

With this configuration, the grains of the developer G carried on the developing roller 13a stand on end on the developing roller 13a due to the magnetic force exerted by the magnetic pole P3, forming a magnetic brush slidingly contacting the small gap portion 13r1, so that the suction airflow by the pump action is reliably formed.

Further, as illustrated in FIG. 6, in the present embodiment, a portion of the sheet member 13s between the root (secured end) 13s1 supported by the cover 13r as the secured end and the free end tip 13s2 as the free end is opposed to the magnetic pole P2. The magnetic pole P2 is one of the plurality of magnetic poles P1 to P5 and different from the magnetic pole P3 opposite the small gap portion 13r1.

With this configuration, the developer G carried on the developing roller 13a stand on end on the developing roller 13a due to the magnetic force exerted by the magnetic pole P2, forming a magnetic brush slidingly contacting the sheet member 13s, so that the above-described functions of the sheet member 13s are stably exhibited. That is, even if air erupts from where the suction airflow is weak in the casing gap H, the sheet member 13s reliably blocks the erupting air.

Note that, in the present embodiment, the portion of the sheet member 13s between the root (secured end) 13s1 and the contact portion 13s3 is opposed to the magnetic pole P2. With this configuration, the above-described effects can be efficiently obtained while the suction airflow from outside the developing device is favorably formed. In particular, since a strong airflow is likely to be generated at the portion of the surface of the developing roller 13a corresponding to the magnetic pole P2, it is useful to make the sheet member 13s contact the portion of the developing roller corresponding to the magnetic pole P2.

In the present embodiment, as illustrated in FIG. 7, the free end tip 13s2 of the sheet member 13s as the free end does not contact the developing roller 13a. That is, the free end tip 13s2 of the sheet member 13s is floating without contacting the developing roller 13a.

With this configuration, regardless of assembly tolerances or component tolerances of the sheet member 13s or the upper cover 13r, the contact state of the sheet member 13s with the developing roller 13a is less likely to change. Further, even if the developing roller 13a is rotated in reverse during maintenance of the developing device 13, the free end tip 13s2 of the sheet member 13s is less likely to curl. For these reasons, the sheet member 13s stably exhibits the above-described functions.

In addition, as illustrated in FIGS. 6 and 7, in the present embodiment, a gap (space) in the rotation direction is formed between the free end tip 13 s2 as the free end of the sheet member 13s and the small gap portion 13r1.

That is, the sheet member 13s does not extend to a boundary between the small gap portion 13r1 and the large gap portion 13r2, but the free end tip 13s2 of the sheet member 13s is disposed away from the boundary across the space. In other words, when the upper cover 13r is viewed from the developing roller 13a along the rotation direction of the developing roller 13a, the root (secured end) 13s1, the flat face, and the free end tip 13s2 of the sheet member 13s, the space formed by the large gap portion 13r2 without interposing the sheet member 13s, and the small gap portion 13r1 are arranged in the described order from upstream.

With this configuration, the above-described functions of the sheet member 13s and the large gap portion 13r2 are stably exhibited. That is, even if air erupts from where the suction airflow is weak in the casing gap H, the erupting air stays in the space formed between the developing roller 13a and the large gap portion 13r2 while being blocked by the sheet member 13s. Then, the air staying in the space is sucked through the casing gap H where the suction airflow is strong into the circulation path of the developing device 13. Further, the suction airflow from outside the developing device 13 is favorably formed. In addition, with the above-described positional relation, a wide space is formed on the back side of the sheet member 13s on the free end side, which is not opposed to the developing roller 13a. Accordingly, the passage of the airflow in the longitudinal direction is sufficient. Therefore, the suction airflow is less likely to vary in the longitudinal direction as compared with the case in which the secured end and the free end are arranged in reverse.

As illustrated in FIG. 6, in the present embodiment, the upper cover 13r includes an entrance gap portion 13r 3 in addition to the small gap portion 13r1 and the large gap portion 13r2. The entrance gap portion 13r 3 is disposed adjacent to and upstream from the large gap portion 13r2 in the rotation direction and a third gap between the upper cover 13r and the developing roller 13a progressively decreases in size from upstream to downstream in the rotation direction. That is, the third gap between the entrance gap portion 13r 3 of the upper cover 13r and the developing roller 13a is substantially wedge-shaped to better direct the air near the development range R between the developing roller 13a and the upper cover 13r along with the rotation of the developing roller 13a, thereby reliably forming the suction airflow in the direction indicated by the blank arrows in FIG. 6.

In addition, in the present embodiment, the sheet member 13s is attached to and cantilevered by the entrance gap portion 13r 3. With this configuration, the sheet member 13s reliably contacts the developing roller 13a with the flat face of the sheet member 13s, trailing along the rotation direction of the developing roller 13a.

As described above, the developing device 13 according to the present embodiment includes the upper cover 13r configured to cover the developing roller 13a downstream from the development range R in the rotation direction and the sheet member 13s cantilevered by the upper cover 13r. The sheet member 13s contacts the developing roller 13a with the flat face of the sheet member while trailing along the rotation direction at the position downstream from the development range in the rotation direction. The upper cover 13r includes the large gap portion 13r2 to form the first gap between the large gap portion 13r2 and the developing roller 13a in the first predetermined range in the rotation direction and the small gap portion 13r1 disposed adjacent to and downstream from the large gap portion 13r2 in the rotation direction to form the second gap (casing gap) H between the small gap portion 13r1 and the developing roller 13a in a second predetermined range in the rotation direction. The second gap is substantially constant in the second predetermined range in the rotation direction. The first gap is larger than the second gap, so toner scattering can be substantially reduced.

As a result, according to the present disclosure, a developing device, a process cartridge, and an image forming apparatus can be provided that minimizes toner scattering.

It is to be noted that, in the above-described embodiments, the second conveying screw 13b2 serving as a collection screw is disposed above the first conveying screw 13b1 serving as a supply screw, and the doctor blade 13c is disposed below the developing roller 13a in the two-component type developing device 13. However, the present disclosure can be applied to a developing device employing a two-component development method in which a second conveying screw serving as a collection screw is disposed below a first conveying screw serving as a supply screw, and a doctor blade is disposed above a developing roller, or another developing device employing the two-component development method in which a plurality of conveyors is horizontally arranged in parallel. Further, the present disclosure can be applied to yet another developing device employing a one-component development method using only toner without carrier as a developer.

In the above-described embodiments, the present disclosure is applied to the developing device 13 in which the developing roller 13a is disposed across a gap from the photoconductor drum 11 as the image bearer. Alternatively, the present disclosure can be applied to a developing device employing the contact type one-component development method, in which a developing roller is in contact with an image bearer.

In such configurations, effects similar to those described above are also attained.

Further, the present disclosure is applied to the developing device 13 that is separately installed in the image forming apparatus 1. However, the present disclosure is not limited to the above described configuration and can be applied to a developing device that is an integral part of a process cartridge together with other components. In this case, workability of maintenance of the image forming unit can be improved.

It is to be noted that the term “process cartridge” used in the present disclosure means a removable unit including an image bearer and at least one of a charging device to charge the image bearer, a developing device to develop latent images on the image bearer, and a cleaning device to clean the image bearer that are united together, and is designed to be removably installed as a united part in the image forming apparatus.

The above-described embodiments are illustrative and do not limit the present disclosure. Thus, numerous additional modifications and variations are possible in light of the above teachings. It is therefore to be understood that within the scope of the present disclosure, the present disclosure may be practiced otherwise than as specifically described herein. The number, position, and shape of the components described above are not limited to those embodiments described above. Desirable number, position, and shape can be determined to perform the present disclosure.

What is claimed is:

1. A developing device configured to develop latent images on a surface of an image bearer, the developing device comprising:
a developing roller configured to rotate in a predetermined direction of rotation and opposed to or in contact with the image bearer to form a development range;
a cover configured to cover the developing roller downstream from the development range in the predetermined direction of rotation, the cover including:
a large gap portion to form a first gap between the large gap portion and the developing roller in a first predetermined range in the predetermined direction of rotation; and
a small gap portion disposed adjacent to and downstream from the large gap portion in the predetermined direction of rotation to form a second gap smaller than the first gap between the small gap portion and the developing roller in a second predetermined range in the predetermined direction of rotation; and
a sheet member cantilevered by the cover and configured to contact the developing roller with a flat face of the sheet member while trailing along the predetermined direction of rotation at a position downstream from the development range.

2. The developing device according to claim 1,
wherein the sheet member is configured to contact the developing roller with the flat face of the sheet member at a position opposite the large gap portion.

3. The developing device according to claim 1,
wherein the developing roller includes a magnetic field generator including a plurality of magnetic poles each having a peak of a normal magnetic force in a predetermined region around an entire circumference of the developing roller in the predetermined direction of rotation, and
wherein the small gap portion is opposed to one of the plurality of magnetic poles.

4. The developing device according to claim 3,
wherein the sheet member has a secured end supported by the cover and a free end tip, and
wherein a portion of the sheet member between the secured end and the free end tip is opposed to another of the plurality of magnetic poles different from the one of the plurality of magnetic poles.

5. The developing device according to claim 1,
wherein a free end tip of the sheet member is contactless with the developing roller.

6. The developing device according to claim 1,
wherein a free end tip of the sheet member is disposed away from the small gap portion across a gap in the predetermined direction of rotation.

7. The developing device according to claim 1,
wherein the cover includes an entrance gap portion disposed adjacent to and upstream from the large gap portion in the predetermined direction of rotation to form a third gap between the entrance gap portion and the developing roller,
wherein the third gap progressively decreases in size from upstream to downstream in the predetermined direction of rotation, and
wherein the sheet member is attached to and cantilevered by the entrance gap portion.

8. The developing device according to claim 1, further comprising a developer regulator disposed opposite and below the developing roller and configured to adjust an amount of developer, and
wherein the cover is configured to cover an upper portion of the developing roller.

9. A process cartridge comprising:
the developing device according to claim 1; and
the image bearer,
wherein the process cartridge is removably installable in an image forming apparatus, and
wherein the developing device and the image bearer are integral parts of the process cartridge.

10. An image forming apparatus comprising:
the developing device according to claims 1; and
the image bearer.
